(19) United States
(12) Patent Application Publication
(10) Pub. No.: US 2015/0375302 A1
(43) Pub. Date: Dec. 31, 2015

(54) METAL NANOPARTICLES AND METHODS FOR THEIR PREPARATION AND USE

(71) Applicant: UNIVERSITY OF CALCUTTA, West Bengal, Kolkata (IN)

(72) Inventor: Nilanjan Deb, Kolkata (IN)

(21) Appl. No.: 14/769,808

(22) PCT Filed: Apr. 15, 2013
(86) PCT No.: PCT/IB2013/052975

§ 371 Date: Aug. 22, 2015

(30) Foreign Application Priority Data
Feb. 27, 2013 (IN) 227/KOL/2013

(51) Int. Cl. B22F 9/24; C02F 1/28; B01J 20/30; B01J 20/02; B01J 20/28

(52) U.S. Cl. CPC B22F 9/24; B01J 20/02; B01J 20/28016; B01J 20/3085; C02F 1/281; C02F 2303/02; C02F 2101/103

(57) ABSTRACT

Methods of synthesizing metal nanoparticles from a metal oxide ore are provided. The methods include adding a metal compound and a reducing agent to the metal oxide ore and contacting the metal compound and the reducing agent to form zero-valent metal nanoparticles. The methods also include contacting the metal oxide ore and hydrogen (H₂) in presence of the zero-valent metal nanoparticles to form zero-valent metal and metal nanoparticles.

### BACKGROUND

In recent years, nanoparticles have become increasingly important in many industrial processes and products. For example nano-scale metals such as zero-valent iron nanoparticles can be used in removing environmental pollutants and for purifying contaminated water. Such nanoparticles can be effective at transformation and removal of organic contaminants and heavy metals such as tetrachloroethylene (TCE), trichloroethylene, chromium, lead, metalloid arsenic and other general environmental pollutants such as nitrate, chloroform, nitrobenzene, nitrotoluene and methane chloride.

Zero-valent iron nanoparticles can be produced by milling of aggregates or microscale particles. Another way of synthesizing zero-valent iron nanoparticles is by reacting ferric chloride (FeCl₃) with sodium borohydride solution. Moreover, iron nanoparticles may also be formed by heating iron pentacarbonyl and by reacting iron oxides with hydrogen.

Commercially available zero-valent iron nanoparticles synthesized using the above techniques have poor air stability and are rapidly oxidized when exposed to air thereby losing their high reactivity. Moreover, these nanoparticles have substantially high particle agglomeration and are inflammable. Many techniques have been developed to suppress oxidation and protect the nanoparticles during drying after synthesis, such as use of an anaerobic chamber, lyophillization and vacuum drying techniques. However, most of these techniques are expensive, tedious and may hinder in various applications of nanoparticle such as in removing environmental pollutants.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

Briefly, in accordance with one aspect, methods of synthesizing metal nanoparticles from a metal oxide ore are provided. The methods include adding a metal compound and a reducing agent to the metal oxide ore and contacting the metal compound and the reducing agent to form zero-valent metal nanoparticles. The methods also include contacting the metal oxide ore and hydrogen (H₂) in presence of the zero-valent metal nanoparticles to form zero-valent metal and metal nanoparticles.

In accordance with another aspect, methods of synthesizing iron nanoparticles from laterite ore are provided. The methods include mixing an iron compound with a solvent to form an iron compound solution and adding a solution of the laterite ore to the iron compound solution to form a laterite ore solution. The methods also include contacting a reducing agent with the laterite ore solution to form zero-valent iron nanoparticles and contacting the laterite ore and hydrogen (H₂) in presence of the zero-valent iron nanoparticles to form zero-valent iron and iron nanoparticles.

In accordance with another aspect, iron nanoparticles are provided. The iron nanoparticles are synthesized from laterite ore by reacting an iron compound and a reducing agent with the laterite ore.

In accordance with another aspect, methods for treating contaminated water are provided. The methods include contacting zero-valent iron and iron nanoparticles with the contaminated water to remove contaminants from the water. The zero-valent iron and iron nanoparticles are synthesized from a laterite ore by reacting an iron compound and a reducing agent with the laterite ore.

### BRIEF DESCRIPTION OF THE FIGURES

FIG. 1 is an example flow diagram of an embodiment of a method of synthesizing metal nanoparticles from a metal oxide ore.

FIG. 2 is an example arrangement of zero-valent metal nanoparticles formed during the process of synthesizing metal nanoparticles from a metal oxide ore.

FIG. 3 is an example transmission electron microscopy (TEM) image illustrating initiation of laterite reduction around zero-valent iron nanoparticles synthesized from ferric chloride (FeCl₃).

FIG. 4 is an example TEM image illustrating formation of zero-valent iron nanoparticles.

FIG. 5 is an example TEM image of the formed zero-valent iron nanoparticles.

FIG. 6 is an example TEM image of spherical zero-valent iron nanoparticles formed by reduction of the laterite.

FIG. 7 is an example TEM image of multiple spherical-shaped zero-valent iron nanoparticles formed by step-wise reduction of the laterite ore.

FIG. 8 is an example TEM image illustrating attachment of multiple zero-valent iron nanoparticles in the laterite solution.

FIG. 9 illustrates XRD pattern of iron nanoparticle synthesized from FeCl₃.

FIG. 10 illustrates XRD pattern of zero-valent iron nanoparticles synthesized from laterite.

FIG. 11 illustrates XRD pattern of zero-valent iron nanoparticles synthesized from laterite.

FIG. 12 is an example transmission electron microscopy (TEM) image of zero-valent iron nanoparticles synthesized from FeCl₃ without further reduction of laterite.

FIG. 13 is an example transmission electron microscopy (TEM) image of zero-valent iron nanoparticles synthesized from laterite autocatalyzed by FeCl₃ and reduced by spill over hydrogen.

FIG. 14 is a graphical representation depicting percentage removal of contaminants from water using zero-valent iron nanoparticles.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

It will also be understood that any compound, material or substance which is expressly or implicitly disclosed in the specification and/or recited in a claim as belonging to a group or structurally, compositionally and/or functionally related compounds, materials or substances, includes individual representatives of the group and all combinations thereof. While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

Some embodiments are generally directed to techniques of synthesizing metal nanoparticles from metal oxide ores. The embodiments described below provide a method of synthesizing metal nanoparticles by reduction of respective metal oxide ores using a metal compound and a reducing agent. A variety of metal nanoparticles such as iron nanoparticles, aluminum nanoparticles, zinc nanoparticles and antimony nanoparticles can be synthesized from their respective metal oxide ores using the present technique. The disclosed technique facilitates synthesis of metal nanoparticles from their respective metal oxide ores under normal temperature and atmospheric conditions. The technique is environment friendly and is substantially cost effective. The metal nanoparticles synthesized using the technique disclosed herein are light in weight, are air stable and can be substantially dispersed in an aqueous medium. Such metal nanoparticles may be used in purification systems such as for treating contaminated water.

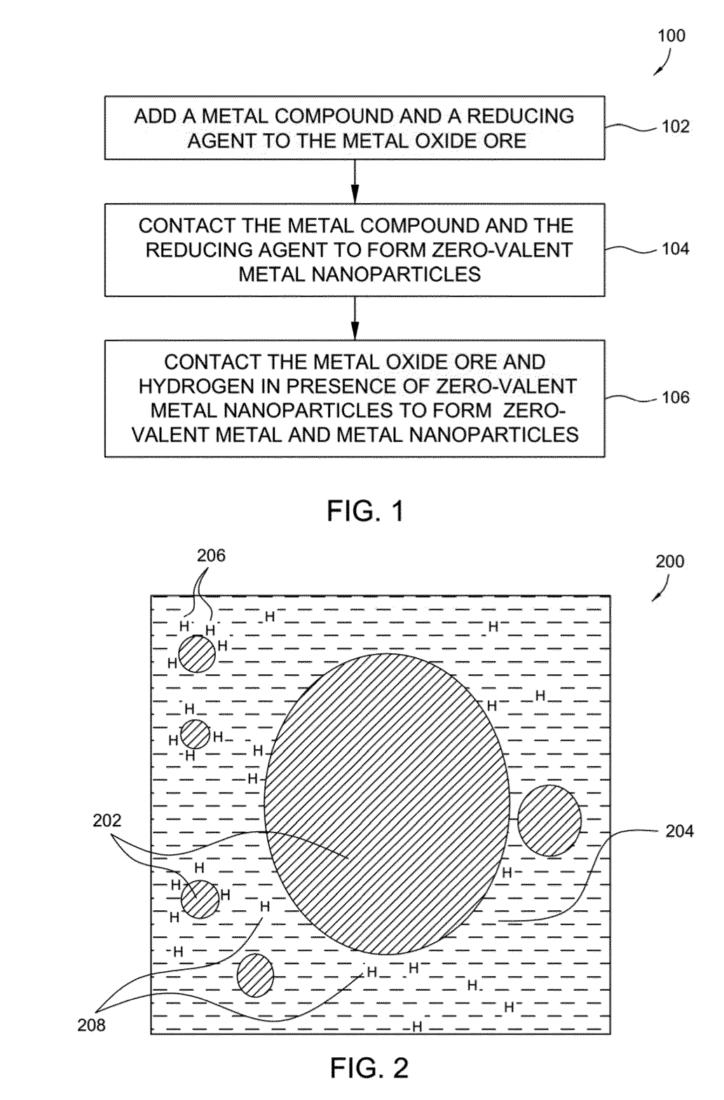

Referring now to FIG. 1, an example flow diagram 100 of an embodiment of a method of synthesizing metal nanoparticles from a metal oxide ore is illustrated. At block 102, a metal compound and a reducing agent are added to the metal oxide ore. In one example embodiment, the metal oxide ore includes laterite ore and the metal compound includes an iron compound used to synthesize zero-valent iron and iron nanoparticles. Examples of the iron compound include, but are not limited to, ferric chloride (FeCl₃), ferric sulphate (Fe₂(SO₄)₃), ferrous sulphate (FeSO₄), ferrous ammoniumsulfate ((NH₄)₂Fe(SO₄)₂.6H₂O), ferrous ammonium phosphate (FeNH₄PO₄), ferrous oxalate (FeC₂O₄), ferrous carbonate (FeCO₃), iron chelate, iron lignosulfonate, iron polyflavonoid, iron methoxyphenyl propane, iron ammonium polyphosphate, iron bromide (FeBr₃), iron oxychloride (FeOCl), iron acetate, iron phosphate, or combinations thereof.

In one example embodiment, a concentration of the iron compound is about 0.1 M to about 10M.

In another example embodiment, the metal oxide ore includes bauxite, the metal compound includes an aluminum compound and the metal nanoparticles include zero-valent aluminum and aluminum nanoparticles respectively. Examples of the aluminum compound include, but are not limited to, aluminum chloride (AlCl₃), aluminum (I) oxide (Al₂O), aluminum (II) oxide, aluminum hydroxide, aluminum hydroxide oxide, or combinations thereof.

In another example embodiment, the metal oxide ore includes sphalerite, the metal compound includes a zinc compound and the metal nanoparticles comprise include zero-valent zinc and zinc nanoparticles respectively. Examples of the zinc compound include, but are not limited to, zinc chloride (ZnCl₂), zinc oxide (ZnO), zinc hydroxide (Zn(OH)₂), zinc sulphide (ZnS), or combinations thereof.

In another example embodiment, the metal oxide ore includes stibnite (Sb₂S₃), the metal compound includes antimony (Sb) compound and the metal nanoparticles include zero-valent antimony and antimony nanoparticles respectively. Examples of the antimony compound include, but are not limited to, antimony trichloride (SbCl₃), antimony pentachloride (SbCl₅), antimony pentaoxide (Sb₂O₅), antimony tetraoxide (Sb₂O₄), antimony pentasulfide, or combinations thereof.

In the illustrated embodiment, the metal compound is mixed with a solvent to form a metal compound solution. Examples of the solvent include, but are not limited to, ethanol, water, pentane (C₅H₁₂), cyclopentane (C₅H₁₀), hexane (C₆H₁₄), cyclohexane (C₆H₁₂), benzene (C₆H₆), toluene 1,4 dioxane, chloroform (CHCl₃), diethylether (C₂H₅)₂O, dichloromethane (CH₂Cl₂), tetrahydrofuran (C₄H₈O), ethyl acetate (C₄H₈O₂), acetone (C₃H₆O), dimethylformamide (C₃H₇NO), acetonitrile (C₂H₃N), dimethyl sulfoxide, propylene carbonate (C₄H₆O), formic acid (CH₂O₂), acetic acid (C₂H₄O₂), n-butanol, isopropanol, n-propanol, methanol, or combinations thereof. In one example embodiment, the solvent includes ethanol and water to minimize oxidation during synthesis of the metal nanoparticles.

Further, a colloidal solution of the metal oxide ore is added to the metal compound solution. For example, laterite ore solution may be added to an iron compound solution for synthesis of iron nanoparticles from the laterite ore. In this example, the laterite ore is present in the laterite ore solution at a concentration of about 2% (w/v) to about 20% (w/v). In one example embodiment, the iron nanoparticles are synthesized from the laterite ore at a temperature of about 10° C. to about 100° C. The reducing agent is then gradually added to contact the metal compound solution while stirring the solution to form zero-valent metal nanoparticles (block 104).

Examples of reducing agent include, but are not limited to, carbon monoxide (CO), sodium borohydride (NaBH₄), lithium borohydride (LiBH₄), hydroquinone (C₆H₄(OH)₂), hydrazine hydrate (H6N₂O), glycol ethylene (C₂H₆O₂), formaldehyde (CH₂O), ethanol (C₂H₆O), hydroxyl radicals, sugar pyrolysis radicals, saccharide, N,N-dimethylformamide, sodium citrate or a combination thereof. In one example embodiment, a concentration of the reducing agent is about 1 M to about 10 M. Moreover, a reaction time for contacting the reducing agent with the metal oxide ore solution is about 1 minute to about 5 minutes.

At block 106, the metal oxide ore and hydrogen are contacted in presence of the zero-valent metal nanoparticles to form zero-valent metal and metal nanoparticles. In this example embodiment, the hydrogen is generated from contacting the metal compound and the reducing agent. In some embodiments, a reaction time for reducing the metal oxide ore in presence of the zero-valent metal nanoparticles is about 1 hour to about 7 days. The zero-valent metal and metal nanoparticles are subsequently extracted from the solution and the extracted nanoparticles may be washed and dried.

FIG. 2 illustrates an example arrangement 200 of zero-valent metal nanoparticles formed during the process of synthesizing metal nanoparticles from a metal oxide ore. In this example embodiment, the zero-valent metal nanoparticles generally represented by reference numeral 202 include zero-valent iron nanoparticles synthesized from laterite ore. Here, an iron compound such as ferric chloride (FeCl₃) is mixed with a solvent such as ethanol mixed with water to form an iron compound solution.

Moreover, a solution of laterite ore is added to the iron compound solution to form a laterite ore solution 204. A reducing agent such as sodium borohydride (NaBH₄) is contacted with the laterite ore solution 204 to form the zero-valent iron nanoparticles 202. The reaction of the reducing agent (NaBH₄) and ferric chloride is represented by the following equation:

2FeCl₃+6NaBH₄+18H₂O→2Fe⁰+6B(OH)³+21H₂+6NaCl (1)

In the illustrated embodiment, the resultant black colloidal solution is then left for spontaneous autocatalytic activity of zero-valent iron nanoparticles 202. As can be seen, hydrogen (H₂) (generally represented by reference numerals 206 and 208) is generated from contacting the laterite ore solution 204 and the reducing agent. This released hydrogen 206 and 208 facilitates further reduction of the laterite ore to form zero-valent iron and iron nanoparticles.

In the illustrated embodiment, some hydrogen atoms 206 remain attached to the zero-valent iron nanoparticles 202, while some hydrogen atoms 208 diffuse into the laterite ore solution 204. These hydrogen atoms 208 contact the laterite ore in presence of the zero-valent iron nanoparticles 202 to form zero-valent iron and iron nanoparticles. The stepwise reduction of the laterite ore containing iron oxide (Fe₂O₃) into zero-valent iron and iron nanoparticles is represented by the following equations:

3Fe₂O₃+H₂→2Fe₃O₄+H₂O (2)

Fe₃O₄+4H₂→3Fe⁰+4H₂O (3)

In this embodiment, the catalysis by zero-valent iron nanoparticles to reduce laterite is due to dissociation of molecular hydrogen 206 from the metal followed by diffusion of adsorbed hydrogen atoms. The hydrogen atoms 206 and 208 facilitate stepwise transformation of laterite (Fe₂O₃) into magnetite and to flatter wusite and finally into finger-shaped, connected iron nanoparticles across the laterite interface. In certain embodiments, heterocatalytic effects of other metal oxides such as oxides of aluminum (Al), copper (Cu), molybdenum (Mo) and titanium (Ti) present in the laterite ore further facilitate reduction of ferrous oxide into iron nanoparticles. During the transformation process, initial spherical magnetite nanoparticles first turn into flatter nanoparticles and finally into spherical zero-valent iron nanoparticles.

In certain embodiments, parameters such as pH of the solution, concentrations of the iron compound and the reducing agent, a stirring speed, a titration rate, a reaction time and reaction temperature may be adjusted to control composition, properties and the morphology of the synthesized iron nanoparticles.

A variety of zero-valent metal and metal nanoparticles can be synthesized from their respective metal oxide ores. In one example embodiment, iron nanoparticles are synthesized from laterite ore using the process described above. The zero-valent iron nanoparticles synthesized from the laterite ore are substantially dispersed particles. In one example embodiment, the zero-valent iron nanoparticles have about 30% to about 60% more dispersion as compared to nanoparticles synthesized from ferric chloride solution. Moreover, a rate of oxidation of the zero-valent iron nanoparticles under ambient conditions is less than about 10%. In certain embodiments, the synthesized zero-valent iron nanoparticles have an average size of about 10 nanometers to about 100 nanometers.

The zero-valent metal and metal nanoparticles such as zero-valent iron and iron nanoparticles synthesized using the process described above may be used in purification systems such as for treating contaminated water. The zero-valent iron and iron nanoparticles are contacted with the contaminated water to remove contaminants from the water. Such zero-valent iron and iron nanoparticles synthesized from the laterite ore have enhanced adsorption potential that facilitates removal of contaminants from water.

Examples of contaminants include, but are not limited to, lead (Pb), arsenic (As), cadmium (Cd), chromium (Cr), nickel (Ni), tetrachloroethylene (PCE), tricholoroethylene (TCE), nitrates, phosphates, sulphides, perchlorate, chlorinated hydrocarbons, trinitrotoluene, halogenated organics, pesticides, organo-arsenicals, organo-mercurials, organic dyes, detergents, inorganic anions, or combinations thereof.

The core of the zero-valent iron and iron nanoparticles includes elemental iron that slowly oxidizes to ferrous iron and releases two electrons. The oxidation of elemental iron can be represented by the following equation:

Fe⁰(s)→Fe²*(aq)+2e⁻¹(aq) (4)

These released electrons facilitate transformation of target contaminants in water. For example, several toxic contaminants such as tetrachloroethylene and trichloroethylene are reductively dechlorinated to an essentially non-toxic mixture of ethane, ethene, and acetylene. It should be noted that, laterite is a mixed valence of iron oxide and aluminum oxide. Aluminum oxide is largely insoluble under neutral pH conditions and may protect the zero-valent nanoparticles core from rapid oxidation. In particular, aluminum oxide facilitates disruption of inter-particle attractive forces and mechanical degradation of aggregates thereby resulting in slow particle agglomeration of the zero-valent nanoparticles. In addition, laterite is an effective adsorption material for removing arsenic, phosphate and other heavy metal contaminants from contaminated water and may also be used to remove odor (H₂S) from contaminated water.

In certain example embodiments, the zero-valent iron nanoparticles synthesized using the process described above may be used as a reducing agent for sequestration of metal ions such as lead (Pb), cadmium (Cd), chromium (Cr), cobalt (Co), copper (Cu), mercury (Hg), nickel (Ni) and selenium (Se) having reduction potential greater than that of iron. The surface of the zero-valent iron nanoparticles is negatively charged that attracts the metal ions. The metal ions are adsorbed on the surface and are gradually reduced to zerovalent ions.

In some example embodiments, the zero-valent iron nanoparticles synthesized from laterite ore are used to adsorb odor such as from contaminated water. Here, alumina removed during laterite reduction may remove contaminants from water and may also remove bad odor from the contaminated water. In this application, alumina acts as a catalyst in the Clauss process for converting hydrogen sulfide waste gases into elemental sulfur. The chemical reactions for the odor removal process are represented by the following equations:

Fe⁺²+H₂S→FeS+2H⁺ (5)

Fe₂O₃H₂O+3H₂S→Fe₂S₃+4H₂O (6)

2Fe₂S₃+3O₂+2H₂O→Fe₂O₃H₂O+6S (7)

After removing contaminants and/or odor from the water, iron nanoparticles may be recovered to restore the adsorption capacity of the exhausted adsorbent. The iron nanoparticles may be removed from treated water by precipitation followed by washing and removal of adsorbed heavy metals. These may further be reduced by a reducing agent followed by separation by magneto-separation process.

### EXAMPLES

The present invention will be described below in further detail with examples and comparative examples thereof, but it is noted that the present invention is by no means intended to be limited to these examples.

### Example 1

### Synthesis of Zero-Valent Iron Nanoparticles from Laterite Ore

Zero-valent iron nanoparticles were synthesized from laterite ore using the example method of FIG. 1. Ferric chloride (FeCb) having a concentration of about 0.18 M was mixed with a solvent containing ethanol and water to form a metal compound solution. The ethanol and water were present in the solvent at a concentration of about 2:1 (viv). The laterite ore was added to metal compound solution to form the laterite ore solution. The laterite ore solution was then contacted with borohydride solution used as a reducing agent to form zero-valent iron nanoparticles.

About 0.75 M of borohydride solution was added to the laterite ore solution in a dropwise manner while stirring vigorously at a speed of about 400 revolutions per minute (rpm) using a magnetic stirrer. A few more drops of the borohydride solution were added to the solution to reduce higher laterite concentrations. The process of reduction of the laterite ore was initiated immediately as the reducing agent was contacted with the ferric chloride solution.

As the reducing agent was contacted with the laterite ore solution, hydrogen was released by catalytic decomposition of the aqueous borohydride solution. This released hydrogen further reduced the laterite ore in presence of the zero-valent iron nanoparticles to form zero-valent iron and iron nanoparticles. This reduction of the laterite ore by the spill-over hydrogen continued for several days. The synthesis of the zero-valent iron and iron nanoparticles from the laterite ore was performed at a temperature of about 30° C.

### Example 2

### Characterization of Zero-Valent Iron and Iron Nanoparticles Synthesized in Example 1

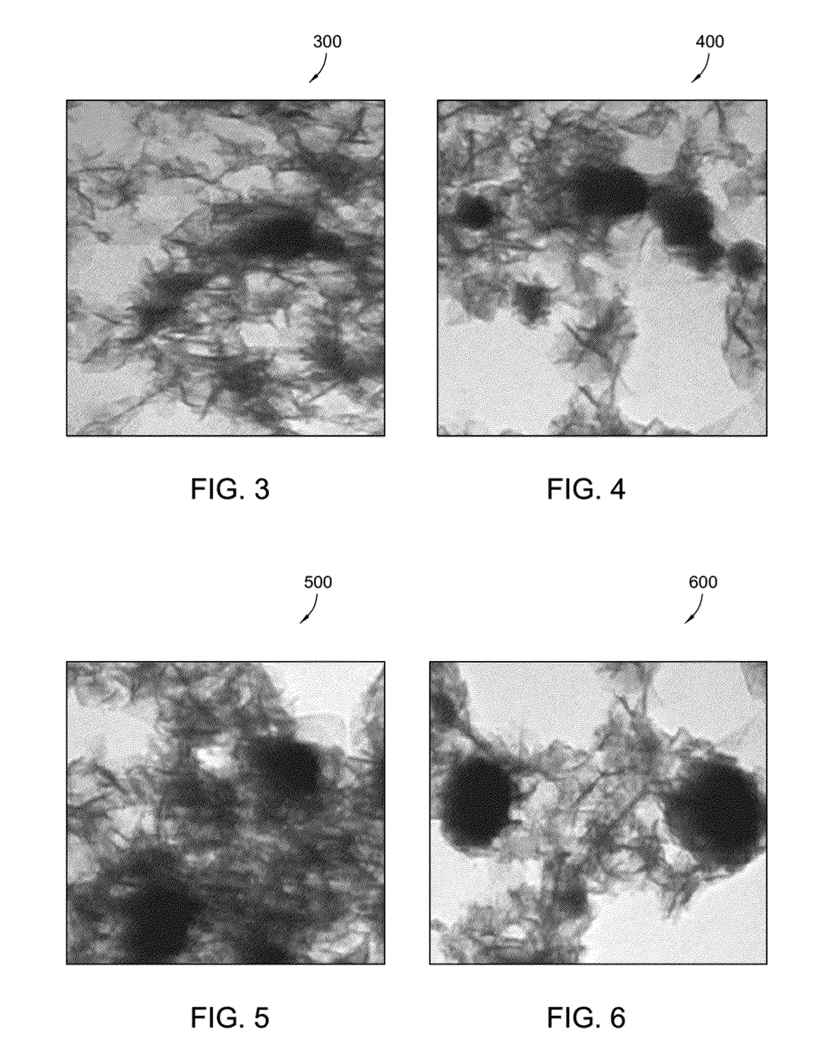

FIG. 3 is an example transmission electron microscopy (TEM) image 300 illustrating initiation of laterite reduction around zero-valent iron nanoparticles synthesized from FeCl₃. As can be seen, the hydrogen released from reduction of FeCh using sodium borohydride solution facilitated laterite reduction around zero-valent iron nanoparticles. FIG. 4 is an example TEM image 400 illustrating formation of zero-valent iron nanoparticles. As can be seen, zero-valent iron nanoparticles were formed by further reduction of the laterite as the hydrogen molecules contacted the laterite ore solution. FIG. 5 is an example TEM image 500 illustrating of the formed zero-valent iron nanoparticles. As can be seen, the size of the formed zero-valent iron nanoparticles increased over a period of time as the hydrogen released from the nanoparticles further reduced the laterite.

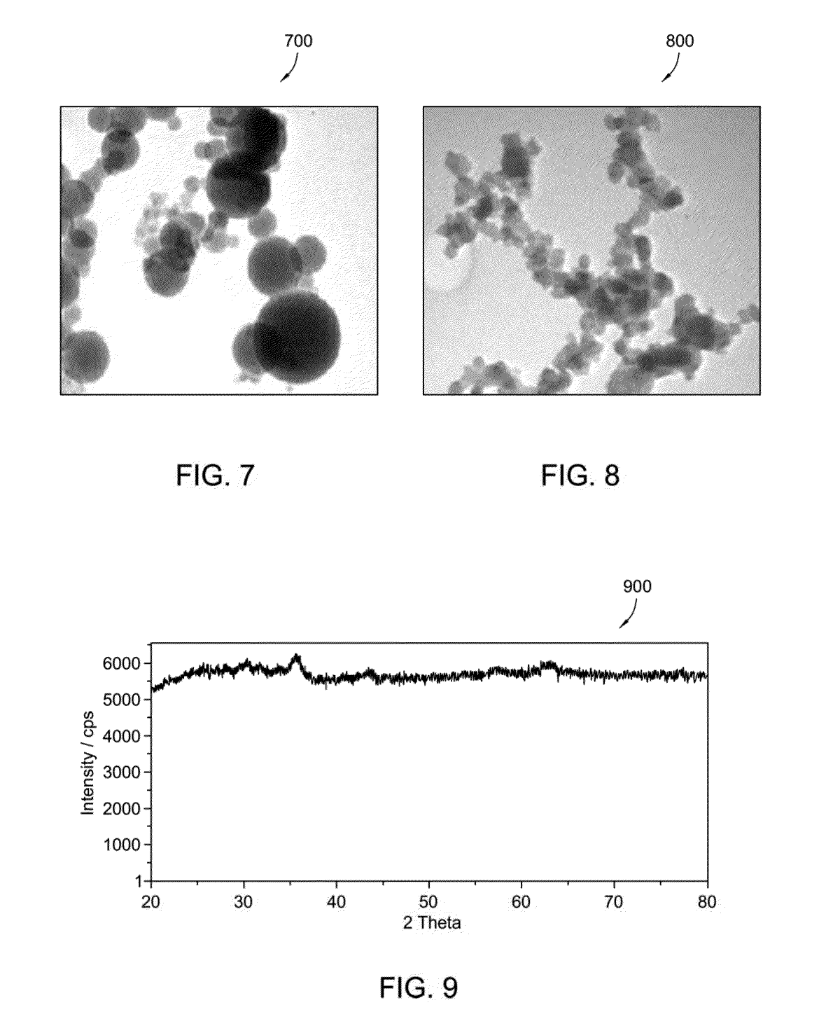

FIG. 6 is an example TEM image 600 of spherical zero-valent iron nanoparticles formed by reduction of the laterite. The initial spherical magnetite nanoparticles first turned into flatter nanoparticles and finally formed spherical zero-valent iron nanoparticles as shown in FIG. 6. FIG. 7 is an example TEM image 700 of multiple spherical zero-valent iron nanoparticles formed by the step-wise reduction of the laterite ore. Here the size of the nanoparticles was measured to be about 10 nm to about 50 nm. FIG. 8 is an example TEM image 800 illustrating attachment of multiple zero-valent iron nanoparticles in the laterite solution. As can be seen, a step-wise transformation of laterite Fe₂O₃ into magnetite and to flatter ZVI NP and finally in to massive finger-shaped connected iron nano-particles was observed.

### Example 3

### Results for the Zero-Valent Iron Nanoparticles

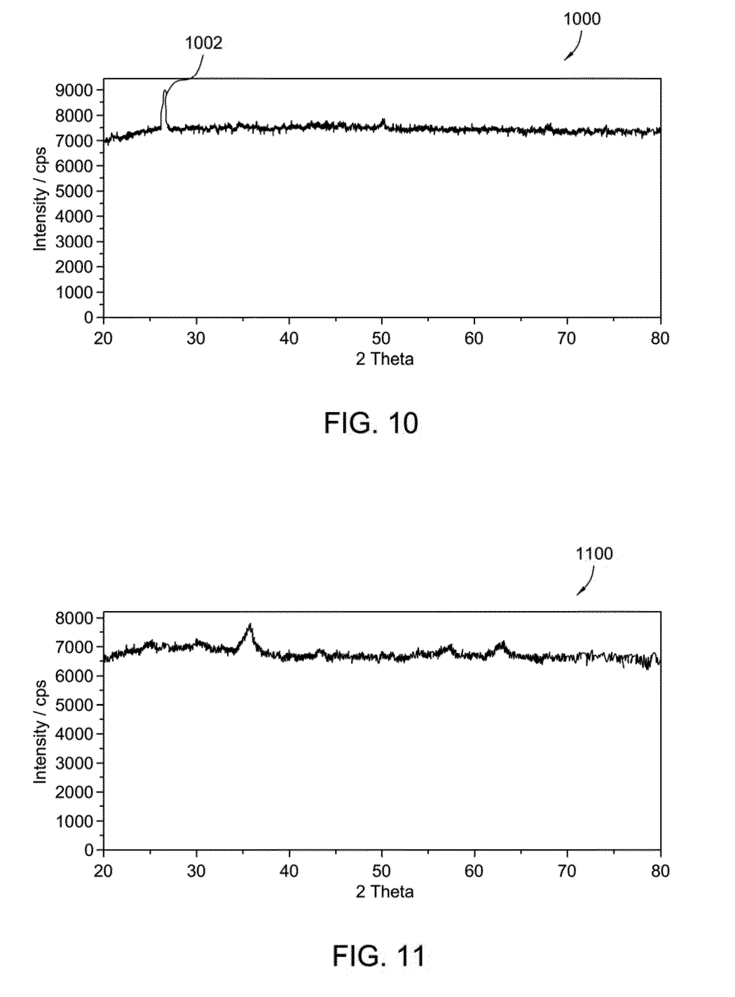

FIG. 9 illustrates XRD pattern 900 of iron nanoparticle synthesized from FeCl₃. The iron nanoparticles were synthesized by reducing FeCl₃ by sodium borohydride solution as the reducing agent. The synthesized iron nanoparticles were stored for about 30 days under atmospheric conditions. FIG. 10 illustrates XRD pattern 1000 of zero-valent iron nanoparticles synthesized from laterite. The zero-valent iron nanoparticles were formed by further reduction of laterite by released hydrogen and the iron nanoparticles were stored under atmospheric conditions for about 24 hours once the reduction process is initiated.

As can be seen, a peak 1002 in the XRD pattern 1000 was observed indicating the presence of laterite in the solution. The peak 1002 was observed as the nanoparticles sample was obtained before completion of the reduction process by the spill-over hydrogen. FIG. 11 illustrates XRD pattern 1100 of zero-valent iron nanoparticles synthesized from laterite. The zero-valent iron nanoparticles were formed by further reduction of laterite by released hydrogen and the iron nanoparticles were stored under atmospheric conditions for about 30 days once the reduction process is initiated. As can be seen, no laterite peak was observed in the XRD pattern 1100, as the process of reduction of laterite by spill over hydrogen was completed.

### Example 4

### Characterization of Dispersion of Iron Nanoparticles Synthesized in Example 1

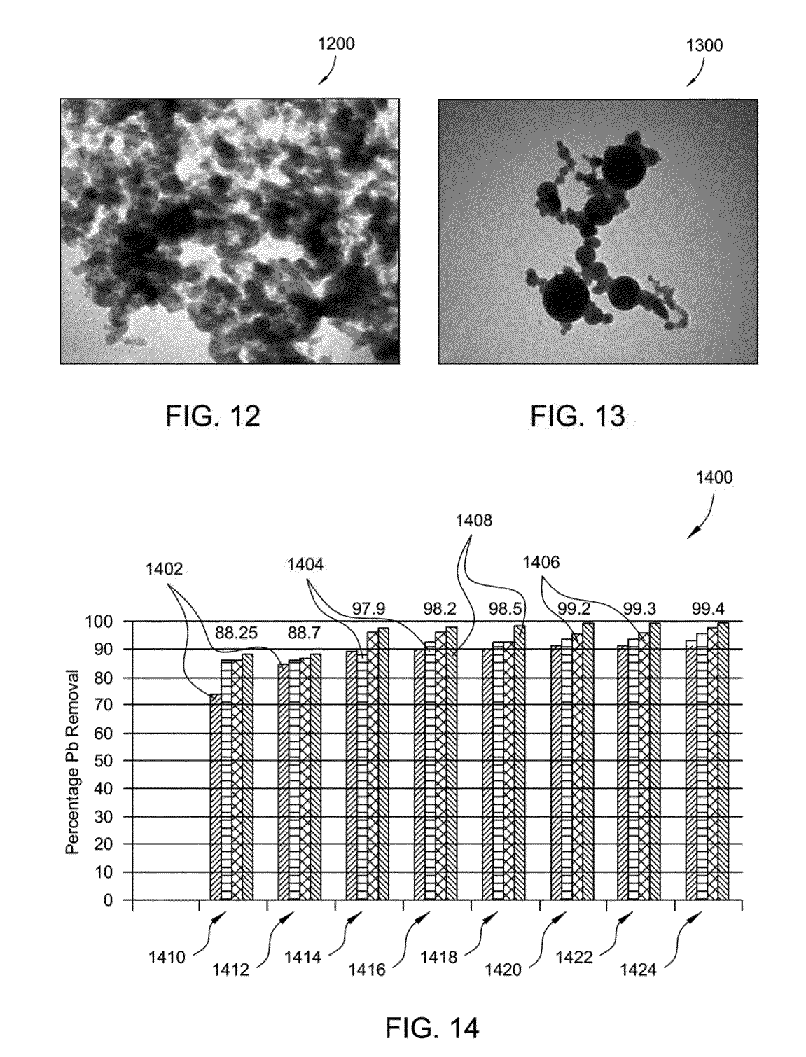

FIG. 12 is an example transmission electron microscopy (TEM) image 1200 of zero-valent iron nanoparticles synthesized from FeCl₃ without further reduction of laterite. As can be seen from the image 1200, there is substantial aggregation of the zero-valent iron nanoparticles present in the laterite solution. FIG. 13 is an example transmission electron microscopy (TEM) image 1300 of zero-valent iron nanoparticles synthesized from laterite autocatalyzed by FeCl₃ reduced by spill over hydrogen. As can be seen from image 1300, the zero-valent iron nanoparticles are substantially spherical in shape and have substantially high dispersion in the medium.

### Example 5

### Experimental Results for Air Stability of Zero-Valent Iron Nanoparticles Synthesized from Laterite Ore

Rate of oxidation of zero-valent iron nanoparticle containing solutions was measured by a simple drop test method on filter paper. Here, about 1 ml of zero-valent iron nanoparticle containing solution was dispensed on a filter paper and time taken for a change in color of the filter paper under ambient conditions was noted. It was observed the laterite reduced zero-valent iron nanoparticles retained their black color even after about 60 days, whereas zero-valent iron nanoparticles synthesized from ferric chloride (FeCl₃) solution alone oxidized within about 60 seconds. The zero-valent iron nanoparticles synthesized from laterite were observed to be about 1000 times more air stable than zero-valent iron nanoparticles synthesized from ferric chloride (FeCl₃) solution alone.

### Example 6

### Experimental Results for Treatment of Contaminated Water Using Zero-Valent Iron Nanoparticles Synthesized from Laterite Ore

FIG. 14 is a graphical representation 1400 depicting percentage removal of contaminants from water using zero-valent iron nanoparticles over a period of time. Lead nitrate was weighed and dissolved in purified water (Milli-Q water) to generate a water sample that contained about 1000 parts per million (ppm) of lead and the pH of the water was reduced to about 4.0 by adding few drops of nitric acid (HNO₃) in the water sample. About 240 ml of solution with zero-valent iron nanoparticles was added to the contaminated water sample. The concentration of zero-valent iron nanoparticles was about 400 mg per liter of the contaminated water sample.

The prepared samples were treated with zero-valent iron nanoparticles over a time period of 6 hours, 12 hours, 24 hours and 48 hours respectively and were tested for presence of lead in the samples using an atomic absorption spectrophotometer. The percentage removal of lead from the samples after 6 hours, 12 hours, 24 hours and 48 hours are represented by reference numerals 1402, 1404, 1406 and 1408.

Here, the results for zero-valent iron nanoparticles synthesized from FeCl₃ solution (new and aged samples) are represented by reference numerals 1410 and 1412 respectively. Moreover, results for zero-valent iron nanoparticles synthesized from FeCl₃ and laterite having a weight ratio of about 1:5 (new and aged samples) are represented by reference numerals 1414 and 1416 respectively. Results for zero-valent iron nanoparticles synthesized from FeCl₃ and laterite having a weight ratio of about 1:10 (new and aged samples) are represented by reference numerals 1418 and 1420 respectively. Further, results for zero-valent iron nanoparticles synthesized from FeCl₃ and laterite having a weight ratio of about 1:20 (new and aged samples) are represented by reference numerals 1422 and 1424 respectively. As can be seen, the zero-valent iron nanoparticles synthesized from laterite had enhanced adsorption potential.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of“two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone. A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art all language such as “up to,” “at least,” “greater than,” “less than,” and the like include the number recited and refer to ranges which can be subsequently broken down into sub ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of synthesizing metal nanoparticles from a metal oxide ore, the method comprising:
adding a metal compound and a reducing agent to the metal oxide ore by:
mixing the metal compound with a solvent to form a metal compound solution;
adding a colloidal solution of the metal oxide ore to the metal compound solution; and
gradually adding the reducing agent to the metal compound solution;
contacting the metal compound and the reducing agent to form zero-valent metal nanoparticles; and
contacting the metal oxide ore and hydrogen (H2) in presence of the zero-valent metal nanoparticles to form zero-valent metal and metal nanoparticles.

2. The method of claim 1, wherein the hydrogen is generated from contacting the metal compound and the reducing agent.

3. The method of claim 1, wherein
the metal oxide ore comprises laterite ore;
the metal compound comprises an iron compound; and
the metal nanoparticles comprise zero-valent iron and iron nanoparticles.

4. (canceled)

5. (canceled)

6. The method of claim 1, wherein the metal compound comprises ferric chloride (FeCl₃), ferric sulphate (Fe₂(SO₄)₃), ferrous sulphate (FeSO₄), ferrous ammonium sulfate ((NH₄)₂Fe(SO₄)₂6H₂O), ferrous ammonium phosphate (FeNH₄PO₄), ferrous oxalate (FeC₂O₄), ferrous carbonate (FeCO₃), iron chelate, iron lignosulfonate, iron polyflavonoid, iron methoxyphenylpropane, iron ammonium polyphosphate, iron bromide, iron oxychloride, iron acetate, iron phosphate, or combinations thereof.

7. The method of claim 1, wherein the metal oxide ore comprises bauxite, the metal compound comprises an aluminum compound and the zero-valent metal and metal nanoparticles comprise zero-valent aluminum and aluminum nanoparticles respectively.

8. The method of claim 7, wherein the aluminum compound comprises aluminum chloride (AlCl₃), aluminum (I)oxide, aluminum (II)oxide, aluminum hydroxide, aluminum hydroxide oxide, or combinations thereof.

9. The method of claim 1, wherein the metal oxide ore comprises sphalerite, the metal compound comprises a zinc compound and the zero-valent metal and metal nanoparticles comprise zero-valent zinc and zinc nanoparticles respectively.

10. The method of claim 9, wherein the zinc compound comprises zinc chloride (ZnCl₂), zinc oxide (ZnO), zinc hydroxide (Zn(OH)₂), zinc sulphide (ZnS), or combinations thereof.

11. The method of claim 1, wherein the metal oxide ore comprises stibnite (Sb₂S₃), and the metal compound comprises antimony (Sb) compound and the zero-valent metal and metal nanoparticles comprise zero-valent antimony and antimony nanoparticles respectively.

12. The method of claim 11, wherein the antimony compound comprises antimony trichloride (SbCl₃), antimony pentachloride (SbCl₅), antimony pentaoxide (Sb₂O₅), antimony tetraoxide (Sb₂O₄), antimony pentasulfide, or combinations thereof.

13. The method of claim 1, wherein the reducing agent comprises carbon monoxide (CO), sodium borohydride (NaBH₄), lithium borohydride (LiBH₄), hydroquinone (C₆H₄(OH)₂), hydrazine hydrate (H₆N₂O), glycol ethylene (C₂H₆O₂), formaldehyde (CH₂O), ethanol (C₂H₆O), hydroxyl radicals, sugar pyrolysis radicals, saccharide, N-dimethylformamide, sodium citrate, or combinations thereof.

14. (canceled)

15. The method of claim 14, wherein the solvent comprises ethanol, water, pentane (C₅H₁₂), cyclopentane (C₅H₁₀), hexane (C₆H₁₄), cyclohexane (C₆H₂), benzene (C₆H₆), toluene 1,4 dioxane, chloroform (CHCl₃), diethylether (C₂H₅)₂O, dichloromethane (CH₂Cl₂), tetrahydrofuran (C₄H₈O), ethyl acetate (C₄H₈O₂), acetone (C₃H₆O), dimethylfonnamide (C₃H₇NO), acetonitrile (C₂H₃N), dimethyl sulfoxide, propylene carbonate (C₄H₆O₃), formic acid (CH₂O₂), acetic acid (C₂H₄O₂), n-butanol, isopropanol, n-propanol, methanol, or combinations thereof.

16. A method of synthesizing iron nanoparticles from laterite ore, the method comprising:
mixing an iron compound with a solvent to form an iron compound solution, wherein the solvent comprises ethanol and water;
adding a solution of the laterite ore to the iron compound solution to form a laterite ore solution;
contacting a reducing agent with the laterite ore solution to form zero-valent iron nanoparticles; and
contacting the laterite ore and hydrogen (H₂) in presence of the zero-valent iron nanoparticles to form zero-valent iron and iron nanoparticles.

17. The method of claim 16, wherein the hydrogen is generated from contacting the laterite ore solution and the reducing agent.

18. The method of claim 16, wherein the iron compound comprises ferric chloride (FeCl₃), ferric sulphate (Fe₂(SO₄)₃), ferrous sulphate (FeSO₄), ferrous ammonium sulfate ((NH₄)2Fe(SO₄)₂.6H₂O), ferrous ammonium phosphate (FeNH₄PO₄), ferrous oxalate (FeC₂O₄), ferrous carbonate (FeCO₃), iron chelate, iron lignosulfonate, iron polyflavonoid, iron methoxyphenylpropane, iron ammonium polyphosphate, iron bromide, iron oxychloride, iron acetate, iron phosphate, or combinations thereof.

19. The method of claim 16, wherein a concentration of the iron compound is about 0.1 M to about 10 M.

20. The method of claim 16, wherein the laterite ore is present in the laterite ore solution at a concentration of about 2% (w/v) to about 20% (w/v).

21. (canceled)

22. The method of claim 16, wherein the ethanol and water are present in the solvent at a concentration of about 2:1 (v/v).

23. The method of claim 16, wherein the reducing agent comprises carbon monoxide (CO), sodium borohydride (NaBH₄), lithium borohydride (LiBH₄), hydroquinone (C₆H₄(OH)₂), hydrazine hydrate (H₆N₂O), glycol ethylene (C₂H₆O₂), formaldehyde (CH₂O), ethanol (C₂H₆O), hydroxyl radicals, sugar pyrolysis radicals, saccharide, N-dimethylformamide, sodium citrate, or combinations thereof.

24. (canceled)

25. The method of claim 16, wherein adding the reducing agent comprises gradually introducing the reducing agent into the laterite ore solution while stirring the solution to form the zero-valent iron nanoparticles.

26. (canceled)

27. (canceled)

28. (canceled)

29. (canceled)

30. The method of claim 16, further comprising:
extracting the zero-valent iron nanoparticles from the solution;
washing the extracted zero-valent iron nanoparticles; and
drying the zero-valent iron nanoparticles.

31. (canceled)

32. (canceled)

33. (canceled)

34. (canceled)

35. A method for treating contaminated water, the method comprising:
contacting zero-valent iron and iron nanoparticles with the contaminated water to remove contaminants from the water, wherein the zero-valent iron and iron nanoparticles are synthesized from a laterite ore by reacting an iron compound and a reducing agent with the laterite ore;
adsorbing odor from the contaminated water through the zero-valent iron and iron nanoparticles; and
eluting the contaminants from the zero-valent iron and iron nanoparticles.

36. The method of claim 35, further comprising contacting the laterite ore and hydrogen (H₂) in presence of the zero-valent metal nanoparticles to form zero-valent metal and metal nanoparticles.

37. The method of claim 35, wherein the iron compound comprises ferric chloride (FeCl₃), ferric sulphate (Fe₂(SO₄)₃), ferrous sulphate (FeSO₄), ferrous ammonium sulfate ((NH₄)₂Fe(SO₄)₂6H₂O), ferrous ammonium phosphate (FeNH₄PO₄), ferrous oxalate (FeC₂O₄), ferrous carbonate (FeCO₃), iron chelate, iron lignosulfonate, iron polyflavonoid, iron methoxyphenylpropane, iron ammonium polyphosphate, iron bromide, iron oxychloride, iron acetate, iron phosphate, or combinations thereof.

38. The method of claim 35, wherein the reducing agent comprises carbon monoxide (CO), sodium borohydride (NaBH₄), lithium borohydride (LiBH₄), hydroquinone (C₆H4(OH)₂), hydrazine hydrate (H₆N₂O), glycol ethylene (C₂H6O₂), formaldehyde (CH₂O), ethanol (C₂H₆O), hydroxyl radicals, sugar pyrolysis radicals, saccharide, N-dimethylformamide, sodium citrate, or combinations thereof.

39. The method of claim 35, wherein the contaminants comprise lead (Pb), arsenic (As), cadmium (Cd), chromium (Cr), and Nickel (Ni), tetrachloroethylene (PCE), tricholoroethylene (TCE), nitrates, phosphates, sulphides, perchlorate, chlorinated hydrocarbons, trinitrotoluene, halogenated organics, pesticides, organo-arsenicals, organo-mercurials, organic dyes, detergents, inorganic anions, or combinations thereof.

40. (canceled)

41. (canceled)
